(19) United States
(12) Patent Application Publication
(10) Pub. No.: US 2005/0268564 A1
(43) Pub. Date: Dec. 8, 2005

(54) Modular window well

(76) Inventor: Morgan Theophilus, Urbandale, IA (US)

Correspondence Address: Brett J. Trout, P.C., Suite 222, 300 S.W. 5th, Des Moines, IA, 50309, US

(21) Appl. No.: 10/864,588

(22) Filed: Jun. 8, 2004

(51) Int. Cl. E06B 5/02; E04F 17/06; B60J 5/04

(52) U.S. Cl. 52/107

(57) ABSTRACT

A modular window well system for constructing window well assemblies at a jobsite. The securement system allows for quick and easy attachment of various window well sections to one another in a manner which substantially eliminates alignment and leveling problems associated with prior art assemblies. The system may also be used with sections of varying depth to create a tiered window well, using the teachings of the present invention.

### BACKGROUND OF THE INVENTION

1. Field of the Invention

The invention relates in general to a modular window well system and, more particularly, to a modular window well system which may be constructed onsite, quickly and easily, to accommodate windows of various depths below grade.

2. Description of the Prior Art

It is known in the art to provide some type of structure around a window located below grade to allow light in and egress out. Although poured concrete and masonry window wells are known in the art, the preferred method of protecting below-grade windows from backfill and the like, is preformed galvanized metal window wells having a generally C-shaped cross section. Given the different depths of windows below grade, window wells of various sizes must be employed. Maintaining a large stock of window wells of various heights is not only expensive, but requires a very large amount of storage space.

To eliminate the need for keeping a large inventory of window wells of various heights in stock, it is known in the art to provide modular window well assemblies. Shorter, modular units can be combined to construct window wells of various heights, using the desired plurality of standard sized units. The desired height may be accomplished by coupling the smaller modular units together either at the factory or onsite. One drawback associated with constructing the assemblies at the factory includes the unwieldiness associated with transporting a large window well assembly to the job site. Another drawback is the inability to adjust the window well onsite, and/or construct a replacement, should the original become damaged.

One drawback associated with constructing the window well on site includes the difficulty in aligning the sections while working below grade. Not only is it difficult to hold the sections in alignment while fastening them together, it is also difficult to avoid coupling the sections together at a cant, with one side having more overlap than the other. An additional drawback associated with constructing the window well onsite is trying to align holes of an attachment fin on one section with the holes of an attachment fin on another section. Typically the holes must be aligned not only with each other, but also with a securement bar which, in turn, is later secured to the foundation of a building. The difficulty and time associated with making all of the appropriate alignments adds additional cost and delay to the window well installation.

Accordingly, it would be desirable to provide a modular window well system which eliminated the need to maintain a large inventory of window wells of various sizes in stock. It would be desirable to provide a modular window well system which could be constructed at the jobsite to avoid the unwieldiness associated with transporting a large window well section, and which provides for quick replacement and/or construction of window wells of a desired height at the jobsite. It would also be desirable to provide a modular window well system which is of an inexpensive lightweight manufacture, and which avoids alignment problems associated with the prior art.

The difficulties encountered in the prior art discussed hereinabove are substantially eliminated by the present invention.

### SUMMARY OF THE INVENTION

In an advantage provided by the present invention, a modular window well section is provided which eliminates the need for maintaining a large plurality of window well heights in stock.

In an advantage provided by the present invention, a modular window well system is provided which substantially elminates tilted securement of modular parts.

In an advantage provided by the present invention, a modular window well system is provided which eliminates problems associated with aligning holes in attachment fins of modular window well sections.

In an advantage provided by the present invention, a modular window well system is provided which eliminates the need for attachment of window well fins to a securement bar and the subsequent attachment to the bar to the foundation of a building.

A modular window well system includes a first window well section coupled to a second window well section. The top of the first window well section is provided with a male lip, coupled into engagement with a female lip that is provided along the bottom of the second window well section. In the preferred embodiment, the male lip comprises a brace plate and a securement plate in engagement with a supplemental brace plate and securement plate of the female lip provided on the second window well section. In the preferred embodiment, both window well sections are provided with attachment fins. The attachment fins are provided with holes but do not overlap. Abutting, rather than overlapping, orientation aids in attachment of the fins directly to the foundation of a building, without having to align holes on the attachment fins.

### BRIEF DESCRIPTION OF THE DRAWINGS

The present invention will now be described, by way of example, with reference to the accompanying drawings in which:

FIG. 1 illustrates a rear perspective view of the window well system of the present invention, shown with the first window well section aligned with the second window well section;

FIG. 2 illustrates a side perspective exploded view of the male lip prior to engagement with the female lip;

FIG. 3 illustrates a side perspective view of the male lip fastened to the female lip, in accordance with the present invention;

FIG. 4 illustrates a side elevation in cross-section of the attachment fins secured to a building;

FIG. 5 illustrates a rear perspective view of the present invention shown with the first window well section secured to the second window well section; and

FIG. 6 illustrates a rear perspective view of an alternative embodiment of the present invention shown with window wells of various depths to create a step window well.

### DETAILED DESCRIPTION OF THE PREFERRED EMBODIMENT

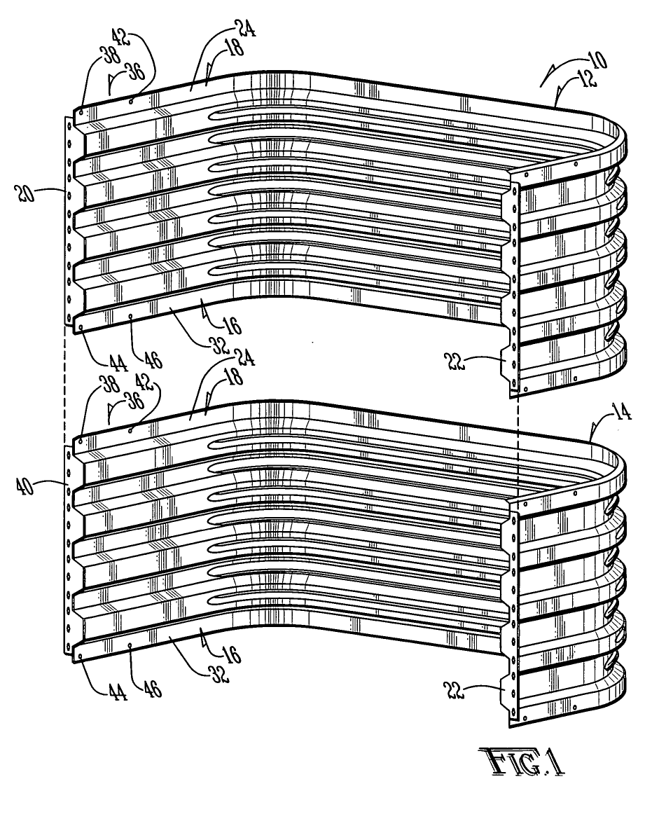

The window well system of the present invention is shown generally as (10) in FIG. 1. The system (10) includes a first window well section (12) and a second window well section (14). Although the window well sections may be constructed of any material known in the art, in the preferred embodiment, the window well sections are constructed of corrugated, galvanized steel in a manner such as that known in the art.

As shown in FIG. 1, the first window well section (12) and second window well section (14) are similar in design, each being provided with a lower female lip (16) and an upper male lip (18). Each window well section (12) and (14) is also provided with a first attachment fin (20) and second attachment fin (22).

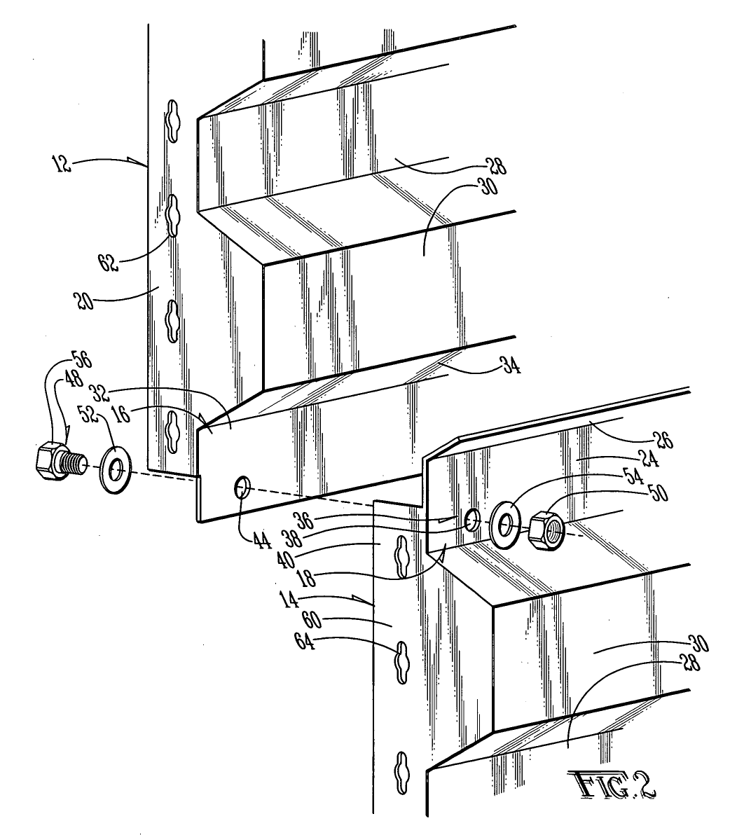

As shown in FIG. 2, the male lip (18) comprises a back or securement plate (24) coupled to a shoulder or brace plate (26). Although the securement plate (24) and brace plate (26) may be constructed of any desired material, in the preferred embodiment they are constructed of galvanized steel and are integrally formed at an obtuse angle, with dimensions substantially identical to the standard sized valleys (28) located between the standard sized ribs (30) of the window well sections (12) and (14). The brace plate (26) preferably extends between 0.1 and 5.0 centimeters beyond the securement plate (24); more preferably between 0.5 and 3.0 centimeters beyond the securement plate (24); and most preferably, about one centimeter beyond the securement plate (24).

As shown in FIG. 2, the female lip (16) includes a supplemental securement plate (32) and a supplemental brace plate (34). As shown, the supplemental brace plate (34) forms one side of one of the ribs (30) of the first window well section (12). While the supplemental securement plate (32) may be of any desired size, in the preferred embodiment, the supplemental securement plate (32) is substantially the same dimensions as the securement plate (24).

As shown in FIGS. 1 and 2, the securement plate (24) is provided with a plurality of holes (36). Preferably, the first hole (38) is centered 3.0 centimeters from the end (40) of the second window well section (14). The second hole (42) is preferably provided 30.0 centimeters from the first hole (38).

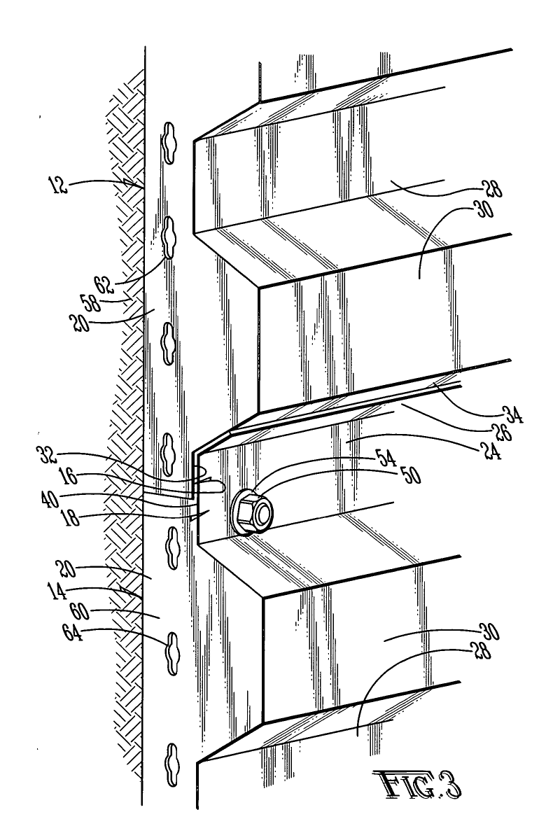

The supplemental securement plate (32) is also provided with a first hole (44) and second hole (46), oriented in a manner which aligns the first holes (38) and (44) and second holes (42) and (46) when the male lip (18) is engaged into the female lip (16). As shown in FIG. 3, the dimensions of the female lip (16) and male lip (18) allow the first window-section (12) to be lowered directly onto the second window well section (14), without having to deform either window well section (12) or (14). The brace plate (26) of the second window well section engages the supplemental brace plate (34) of the first window well section (12). The first hole (38) and second hole (42) of the second window well sections (14) are then aligned with the first hole (44) and second hole (46) of the first window well section (12). (FIGS. 1-3). A bolt (48) is then provided through a washer (52) and inserted through the first holes (38) and (44). A washer (54) is then provided over the bolt (48), and a nut (50) is thereafter secured to the bolt (48). Preferably, as shown in FIG. 2, the head (56) of the bolt (48) is provided on the side of the window well sections (12) and (14) in contact with the soil (58).

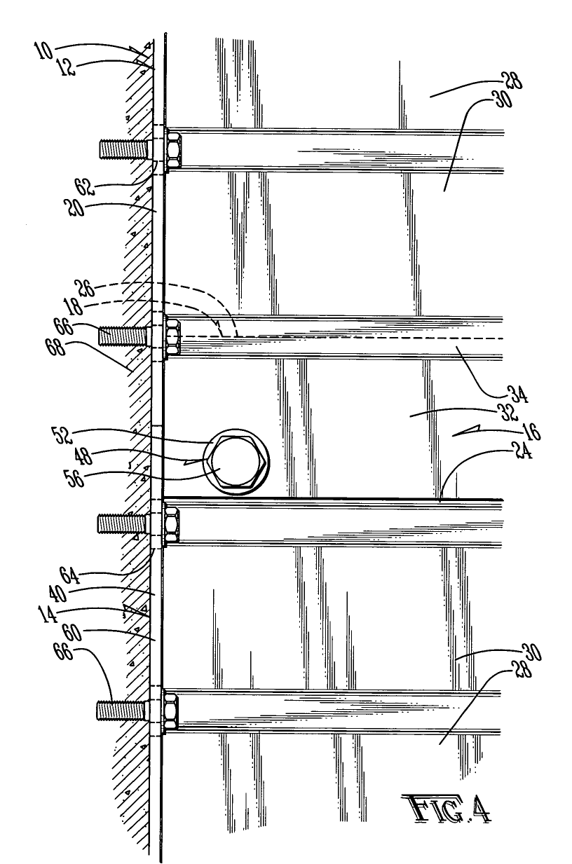

As shown in FIG. 3, when the securement plate (24) is engaged with the supplemental securement plate (32), the attachment fin (22) of the first window well section (12) is immediately adjacent the attachment fin (60) of the second window well section (14). While the attachment fin (22) of the first window well section (12) may overlap the attachment (60) of the second window well section (14), or may instead be positioned a centimeter or more away, in the preferred embodiment, the attachment fin (22) of the first window well section (12) directly abuts the attachment fin (60) of the second window well section (14). It is important that no part of either attachment fin (22) or (60) overlaps the other to the point where either attachment fin (22) or (60) covers the holes (62) and (64) respectively associated with the attachment fin (22) and attachment fin (60), through which bolts (66) or the like are used to attach the attachment fins (22) and (60) directly to a building (68). (FIGS. 3 and 4).

Although in the prior art it is known to overlap the fins to the point where respective holes align to allow bolts to be secured therethrough, such prior art devices require precise alignment between the fins, which is often difficult to accomplish while actually on a jobsite. Additionally, by eliminating the overlapping and alignment of the fins, there is no need for a prior art mounting bar, to which prior art fins are typically attached before attaching the mounting bar itself to a building or other structure. As shown in FIG. 4, when it is desired to attach the system (10) to the building (68), the bolts (66) are provided through the holes (62) and (64), and secured to the building (68) by any means known in the art.

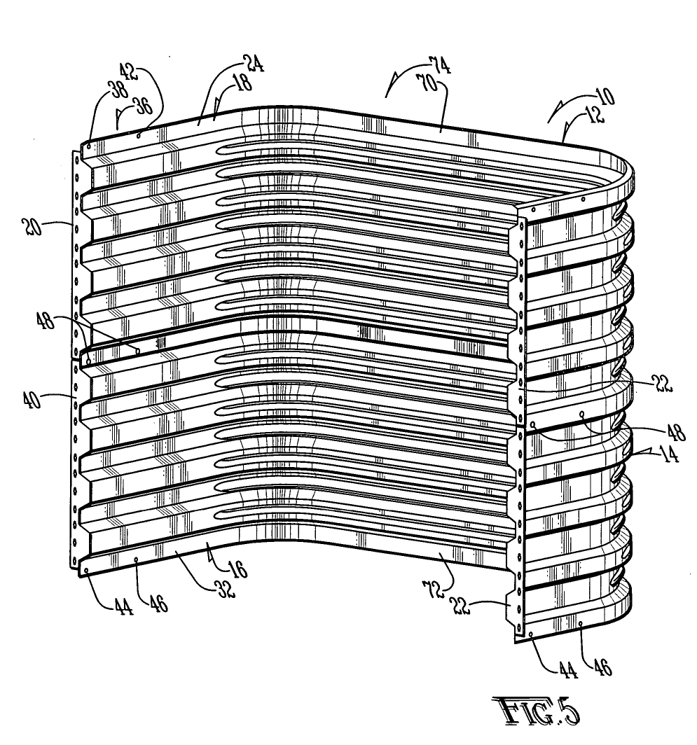

As shown in FIG. 5, the window well sections (12) and (14) are secured together utilizing a pair of bolts (48) positioned thirty centimeters apart on either side of the window well sections (12) and (14), and by another pair of bolts (48) securing the faces (70) and (72) of the window well sections (12) and (14) together in a manner such as that described above, resulting in a window well assembly (74) of any desired height. As shown in FIG. 3, it is desirable to have the brace plate (26) angled similarly to the supplemental brace plate (34) so that when the window well sections (12) and (14) are secured together, the brace plate (26) rests on and supports the supplemental brace plate (34).

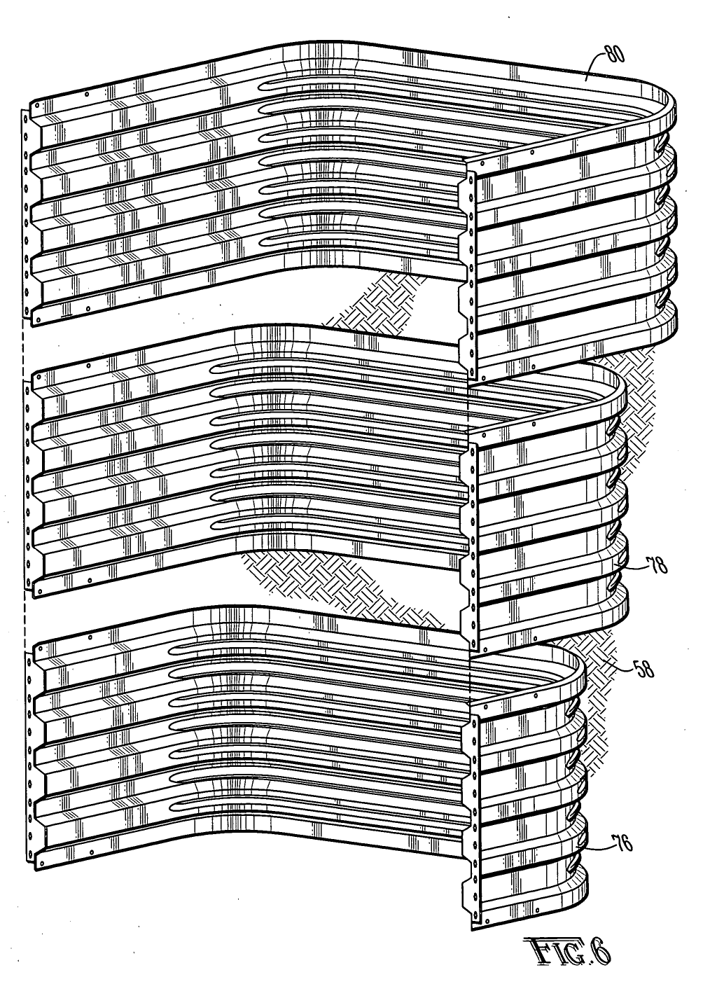

Alternatively, as shown in FIG. 6, window well sections (78) and (80) may be provided of different depths to create a tiered effect with the soil (58) in a manner such as that known in the prior art, to allow for decorative terracing and/or ease of egress past the window well sections (76), (78) and (80).

Although the invention has been described with respect to a preferred embodiment thereof, it is to be also understood that it is not to be so limited, since changes or modifications can be made therein which are within the full, intended scope of this invention as defined by the appended claims. For example, it should be noted that the window well sections (12) and (14) may be constructed of any suitable height, width, configuration or cross-section, and may be constructed of any suitable materials. Additionally, it should be noted that the window well sections (12) and (14) may not be similar to each other in construction, and may be secured to other window well sections of the present invention to create any desired resulting assembly of sections.

1. A modular window well comprising:
(a) a first window well section;
(b) a male lip provided along at least a portion of said first window well section;
(c) a second window well section;
(d) a female lip provided along at least a portion of said window well section;
(e) wherein said female lip is operably engaged with said male lip in a manner which prevents movement of said first window well toward said second window well, and which allows movement of said first window well away from said second window well section; and
(f) a plurality of fasteners securing said male lip to said female lip.

2. The modular window well of claim 1, wherein said male lip comprises:
(a) a securement plate; and
(b) a brace plate secured to said securement plate.

3. The modular window well of claim 2, wherein said securement plate defines said first plurality of openings.

4. The modular window well of claim 2, wherein said female lip comprises;
(a) a supplemental securement plate; and
(b) a supplemental brace plate secured to said supplemental securement plate.

5. The modular window well of claim 4, wherein said supplemental securement plate defines said second plurality of openings.

6. The modular window well of claim 2, wherein said securement plate connects to said brace plate at an obtuse angle.

7. The modular window well of claim 1, further comprising an attachment fin provided on said first window well section.

8. The modular window well of claim 7, further comprising a fastener provided through said attachment fin and secured to a building.

9. The modular window well of claim 1, wherein said first window well section and said second window well section are substantially U-shaped.

10. The modular window well of claim 1, wherein said plurality of fasteners maintains said male lip and said female lip in an overlapped orientation.

11. The modular window well of claim 10, wherein said male lip and female lip are engaged with no more than about ten centimeters of vertical overlap.

12. The modular window well of claim 1, wherein at least a portion of said second window well section extends laterally beyond said first window well section at least twenty centimeters.

13. The modular window well of claim 1, wherein a first side of said first window well section is secured to a first side of said second window well section, wherein a second side of said first window well section is secured to a second side of said second window well section, wherein a third side of said first window well section is positioned at least twenty centimeters lateral of a third side of said second window well section, wherein said first side and said second side of said first window well section and said first side and said second side of said second window well section are secured to a building, and wherein a sufficient amount of earth is provided between said third side of said first window well section and said third said of said second window well section to form a step.

14. A window well system comprising:
(a) a first window well section comprising:
(i) a first attachment fin, and
(ii) a male lip having a shoulder and a back provided with a first opening.
(b) a second window well section comprising:
(i) a second attachment fin,
(ii) a female lip provided with a second opening, and
(iii) a strengthening rib; and
(c) means provided through said first opening and said second opening for securing said first window well section to said second window well section in a manner which secures said back of said male member to said female lip, and which secures said shoulder of said male member along said strengthening rib.

15. The window well system of claim 14, wherein said first attachment fin is provided with a first plurality of holes, wherein said second attachment fin is provided with a second plurality of holes, further comprising a first plurality of fasteners securing said first attachment fin to a building through said first plurality of holes, and a second plurality of fasteners securing said second attachment fin to said building through said second plurality of holes, wherein no fastener is provided through both a hole of said first plurality of holes and a hole of said second plurality of holes.

16. The window well system of claim 14, wherein said first attachment fin is secured to a building by a first plurality of fasteners, wherein said second attachment fin is secured to said building by a second plurality of fasteners, wherein no fastener is secured to said building through said first attachment fin and said second attachment fin.

17. The window well system of claim 14, wherein said back is coupled to said shoulder at an obtuse angle.

18. A method for mounting a window well system to a building comprising:
(a) a first window well section comprising:
(i) a first attachment fin, and
(ii) a male lip having a shoulder and a back provided with a first opening.
(b) a second window well section comprising:
(i) a second attachment fin,
(ii) a female lip provided with a second opening, and
(iii) a strengthening rib; and
(c) fastening said first window well section to said second window well section in a manner which positions said back of said male member with said female lip and which positions said shoulder of said male member along said strengthening rib; and
(d) attaching said first attachment fin and said second attachment fin to a building with a fastener.

19. The method for mounting a window well system to a building of claim 18, further comprising attaching said first attachment fin and said second attachment fin to a building with a plurality of fasteners in a manner in which no fastener penetrates both said first attachment fin and said second attachment fin.

20. The method for mounting a window well system to a building of claim 18, further comprising overlapping said first window well section and said second window well section vertically no more than about ten centimeters.
